(19) United States
(12) Patent Application Publication
(10) Pub. No.: US 2009/0070885 A1
(43) Pub. Date: Mar. 12, 2009

(54) Integrity Protection

(75) Inventor: John David Mersh, Bottisham (GB)

Correspondence Address: EDELL, SHAPIRO & FINNAN, LLC, 1901 RESEARCH BOULEVARD, SUITE 400, ROCKVILLE, MD, 20850, US

(73) Assignee: MStar Semiconductor, Inc., Grand Cayman (KY)

(21) Appl. No.: 12/201,124

(22) Filed: Aug. 29, 2008

Related U.S. Application Data
(63) Continuation of application No. PCT/GB07/00702, filed on Feb. 28, 2007.

(30) Foreign Application Priority Data
Mar. 9, 2006 (GB) 0604784.9

(51) Int. Cl. G06F 12/14; G06F 21/24

(52) U.S. Cl. 726/27; 713/193

(57) ABSTRACT

A data processing system comprising data processing means, control means and an integrated circuit chip containing non-volatile storage, wherein the control means is provided between said chip and the processing means and provides all access to said chip by the processing means and the control means is arranged to check, upon the processing means requiring certain material in the non-volatile storage means, the validity of the required material and prevent the use of the required material by the processing means if invalid. The invention also relates to corresponding methods and to programs for implementing those methods.

The present invention relates to methods of, and apparatus for, checking the validity of material held in non-volatile storage, particularly (but not exclusively) in the context of mobile devices. In the context of this document, the term “mobile device” is intended to cover mobile telephones, personal digital assistants (PDAs), laptop computers, tablet PCs and the like.

A mobile device may be the subject of many different forms of attack. For example, a thief may wish to alter the International Mobile Equipment Identifier (IMEI) of a stolen phone or may wish to circumvent a Subscriber Identity Module (SIM) lock on a stolen mobile phone. Moreover, a hacker may wish to extract a digital rights management (DRM) key and use it to decrypt, say, a music file to generate a version of the file that can be disseminated for playback without copyright fees being paid. Mobile devices are also exposed to mal-ware, for example in the shape of viruses and adware, which might seek unauthorised access to, or modification of program code or data within the device.

Presently, such threats are typically addressed by integrating with a processor in a mobile device a security device that implements certain counter measures in an effort to achieve a required level of security. However, there is now a tendency to include multiple processors within a mobile device since this can lead to increased performance and reduced power consumption. When a plurality of processors, each with its own security device, are brought together within a single mobile device, vulnerabilities can arise in the security of the overall system because, for example, the security devices attached to the processors may well have different functionality (this is especially true if the processors originate from different manufacturers).

Another trend in the design of mobile devices, particularly in the design of mobile telephones, is the use of large capacity non-volatile storage devices, such as NAND flash memories. Such memories are incapable of random access and therefore a processor within a mobile device containing such a memory must read information from that memory into a random access memory (RAM) before utilising that information.

According to one aspect, the invention provides a data processing system comprising data processing means, control means and an integrated circuit chip containing non-volatile storage, wherein the control means is provided between said chip and the processing means and provides all access to said chip by the processing means and the control means is arranged to check, upon the processing means requiring certain material in the non-volatile storage means, the validity of the required material and prevent the use of the required material by the processing means if invalid.

By checking the validity of the required material (which may be, for example, program code, data or a combination of the two), control is asserted over the behaviour of the data processing system thus assisting maintenance of the security of the system.

It may be the case that the control means is not physically located between the processing means and the integrated circuit chip. It may be the case that the control means is merely located in the communication path between the processing means and the integrated circuit chip.

The control means may prevent the use of the required material by, for example, refusing to deliver that material to the processing means or to storage associated with the processing means.

The integrated circuit chip containing non-volatile storage may be, for example, a NAND flash memory chip.

The processing means may be, for example, a group of processors or a single processor.

In certain embodiments, the processing means and the control means are integrated together as part of a system on a chip.

The data processing system itself may be, or may form part of, a mobile telephone (e.g. for a 3G network). Of course, the data processing system may be put to other applications.

By way of example only, certain embodiments of the invention will now be described with reference to the accompanying drawings, in which:

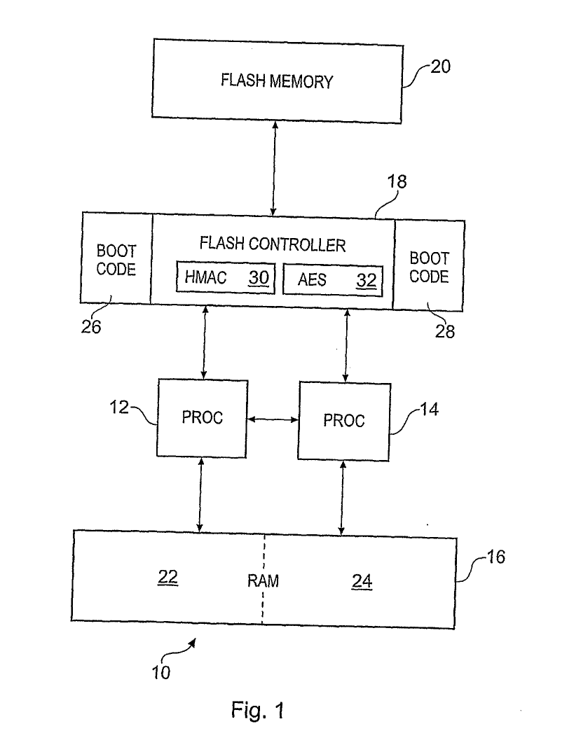

FIG. 1 is a schematic diagram of a mobile telephone.

### DETAILED DESCRIPTION OF THE DRAWINGS

FIG. 1 illustrates a mobile telephone 10. The figure shows only those parts of the telephone 10 that are necessary for describing the invention; it will be appreciated that many parts of the telephone (for example the antenna, the keypad, the power source, the display device and the casing) have been omitted for reasons for brevity and clarity. As shown i

n FIG. 1, the telephone 10 comprises two processors, 12 and 14, a RAM 16, a flash controller 18 and a NAND flash memory 20. Double-headed arrows are used in FIG. 1 to indicate the communication paths that these elements use to communicate data and/or instructions amongst themselves.

Processor 14 is a modem processor and, as such, is responsible, amongst other things, for demodulating information from a digitised version of a carrier signal received at an antenna (not shown) of the telephone 10 and for modulating information onto a digital version of a carrier signal that is destined for transmission from the antenna. Processor 12 is an application processor which, amongst other things, utilises information demodulated by the modem processor 14, sends to the processor 14 information that needs to be transmitted from the telephone 10, controls higher-level aspects of the transmission and reception functions of the telephone and drives the display screen (not shown) and speaker (not shown) of the telephone.

The flash controller 18 controls the access of the processors 12 and 14 to the contents of the flash memory 20. For example, the flash controller 18 arbitrates between conflicting requests by the processors 12 and 14 to access the same region of the flash memory 20. The flash controller contains two areas of read only memory (ROM) 26 and 28, which areas contain boot-strap code for processors 12 and 14, respectively.

The RAM 16 is divided into blocks 22 and 24. RAM block 22 is only accessible by processor 12 and RAM block 24 is only accessible by processor 14.

The flash controller 18, the application processor 12, the modem processor 14 and the RAM 16 are integrated on the same piece of silicon as a so-called “system on a chip” (SoC). This advantageously increases the difficulty of gaining unauthorised access to the communications passing between the elements 12 to 18.

As mentioned earlier, the processors 12 and 14 can only access the flash memory 20 through the flash controller 18. The flash controller 18 contains an HMAC secure message digest mechanism and an AES (Advanced Encryption Standard) encryption mechanism. The HMAC and AES standards are described in the Federal Information Processing Standards (FIPS) publications 198 and 197, respectively.

When retrieving material (be it data, instructions or a combination of both) from the flash memory 20 for one of the processors 12 and 14, the flash memory controller 18 can use the HMAC mechanism 30 to verify the integrity of that material and can use the AES mechanism 32 to decrypt that material if it is stored in encrypted form in the flash memory 20. Retrieved material is written by the flash controller 18 into the RAM block of the requesting processor by direct memory access (DMA) so as to direct the material to the correct processor in a secure manner.

When writing material (be it data, instructions or a combination of both) to the flash memory 20 for one of the processors 12 and 14, the flash controller 18 can use the HMAC mechanism 30 to calculate a digital signature for that material and can use the AES mechanism 32 to, if required, encrypt that material. The keys that are used by the HMAC mechanism 30 and the AES mechanism 32 are stored in a ROM (not shown) within the flash controller 18, which ROM is not accessible to the processors 12 and 14. These keys are unique to the telephone 10.

Various types of data are stored in the flash memory 20. For example, the flash memory 20 contains the IMEI of the telephone 10, SIM lock data and DRM keys. As mentioned earlier, the boot code 26 and 28 for the processors 12 and 14 is stored within the flash controller 18. All of the other program code that is to be used by the processors 12 and 14 is stored in the flash memory 20. The flash memory 20 is a standard, off-the-shelf chip.

The flash controller 18 allocates the material in the flash memory 20 into different sets, each set having its own access, integrity and confidentiality settings. The definitions of these sets, including the aforementioned settings, are stored within the flash memory 20. The flash memory controller 18 deems this group of definitions to be special set, hereinafter referred to as the set definition table. Each set definition consists of:
a base address and maximum size for the set, together identifying the region of the flash memory 20 that is allocated for the set.
an integrity flag indicating whether or not the material in the set is signed with an HMAC digital signature.
an encryption flag indicating whether or not the material in the set is subject to AES encryption.
two access flags, one serving to indicate whether processor 12 has access to the set and the other indicating whether processor 14 has access to the set.

The set definition table is accessible to both processors and includes an HMAC digital signature established on the set definitions in that table using the telephone's unique HMAC key.

### Boot Procedure

The flash controller 18 is arranged to have control of the reset signals of the processors 12 and 14. When the system shown in FIG. 1 boots, the flash controller 18 holds the processors 12 and 14 in reset mode. The flash controller 18 then initialises itself and reads the set definition table from the flash memory 20 and checks the authenticity of that table by submitting the data representing that table to its HMAC mechanism 30 to produce, with the aid of the appropriate key, a digital signature for the set definitions in that table. The flash controller 18 then accepts the definition table as authentic if the signature so produced matches the HMAC digital signature that is appended to the set definition table. If the definition table fails the integrity check, then the flash controller 18 terminates the boot process. If the definition table is deemed authentic, then the flash controller performs similar integrity checks on a selection of sets in the flash memory 20. If any of those sets fail their integrity checks, then the flash controller 18 terminates the boot process.

Provided that the integrity checks on the definition table and the selected sets are successful, the flash controller 18 then continues the boot procedure by removing its reset signal from that processor such that that processor then reads the boot code held in ROM area 26. In a similar manner, the flash controller 18 permits processor 14 to boot, using the boot code stored in ROM area 28. In this way, the flash controller 18 guarantees that the processors 12 and 14 are booted reliably. Once this is complete, the processors 12 and 14 apply to the flash controller 18 to read the material from the flash memory 20 that they require in order to become fully operational. Material that is retrieved from the flash memory 20 for this purpose, typically program code, is retrieved using a read access procedure that will shortly be described. Accordingly, the operation of the processors 12 and 14 is secured.

Reading from the Flash Memory

When one of the processors 12 and 14 submits a request to the flash controller 18 to read material from a set in the flash memory 20, the flash controller performs the following sequence of steps, hereinafter referred to as the read access procedure:
The flash controller 18 accesses the set definition table and reads the access flag of the set for that processor. If the access flag indicates that the requesting processor does not have permission to access the set in question, then the read access procedure is terminated
If the access flag indicates that the requesting processor has access permission, then the read access procedure continues with the flash controller 18 checking the encryption flag of the target set in the set definition table. If that flag indicates that the requested set is confidential and protected by encryption, the flash controller 18 decrypts the requested material using the AES mechanism 32 with an appropriate key.
The flash controller 18 checks the integrity flag of the target set in the set definition table. If the flag indicates that the set does not contain a digital signature for the material in that set, then the requested material is simply delivered to the requesting processor. However, if the integrity flag indicates that the target set does contain an HMAC signature established on the material in that set, then the flash controller 18 applies the HMAC mechanism 30 to the requested material, using the appropriate key. If the signature yielded by this process does not match the signature from within the set, then the read access procedure terminates.

If the two signatures match, then the requested material is delivered to the processor and the read access procedure terminates.

### Writing to the Flash Memory

When one of the processors 12 and 14 desires to write material to a particular set in the flash memory 20, the processor applies to the flash controller 18, which initiates the following sequence of steps, hereinafter referred to as the write access procedure:
The flash controller 18 examines the access flag in the set definition table that specifies whether the requesting processor has access to the requested set. If that access flag indicates that the processor does not have access to the requested set, then the write access procedure terminates.
If, however, the processor has access to the requested set, then the flash controller 18 reads from the processor the material that is to be written to the set.
The flash controller 18 then examines the integrity flag provided in the set definition table for the set to determine whether material placed in that set requires an HMAC signature. If that flag indicates that an HMAC signature is required, then the flash controller 18 submits that material to its HMAC mechanism 30 and thus, using the appropriate key, generates an HMAC signature for the material.
The flash controller 18 examines the confidentiality flag provided for the set in the set definition table. If that flag indicates that material placed in that set is to be encrypted, then the flash controller 18 submits the material to its AES mechanism 32, which encrypts the material using the appropriate key.
The flash controller 18 then writes the material, in its encrypted form if encryption was carried out, and including a signature if HMAC processing was performed, to the requested set in the flash memory 20.
The write access procedure then terminates.

### Flash Memory Initialisation Mode

The flash controller 18 has an initialisation mode which is used when the flash memory 20 contains an initial production image for which the flash controller 18 has not constructed a definition table. The initialisation mode is also used when the telephone receives an update to the program code that is to be used by one or more of the processors. The initialisation mode is also used when the flash memory 20 is supplied empty.

In the initialisation mode, the flash controller 18 allows only processor 12 to boot up. The program code that is executed by the processor 12 in the initialisation mode is retrieved from a ROM within the SoC so that the operation of the processor 12 in that mode can be guaranteed. In the initialisation mode, the processor 12 can update any set in the flash memory 20, including the set definition table. By inhibiting processor 14 from booting, the telephone 10 is prevented from entering a fully functional state whilst the telephone is in the initialisation mode.

If the flash controller 18 is presented with the situation where the flash memory 20 contains an initial production image, then the flash controller 18 reads sets of material from the flash memory 20 those sets of material whose access flags assert that HMAC signatures are required and calculates HMAC signatures for them. The flash controller 18 can, if required, go further and write the sets back to the flash memory 18 in an encrypted form.

When a program code update needs to be applied to a set in the flash memory 20, then that program code is subjected to the HMAC mechanism 30 to produce a digital signature and, provided that encryption is desired, to the AES mechanism 32 for encryption and is then submitted to the relevant set in the flash memory 20.

In the initialisation mode, the processor 12 checks that material for which a HMAC signature is to be produced is signed with a key indicating that the material originates from a trusted party (e.g. the manufacturer of the telephone 10).

### Other Embodiments

In the main embodiment, the read access procedure does not return requested material to a processor until the HMAC mechanism 30 has produced a signature for that material and that metric has been successfully matched against the HMAC signature that is appended to the material. In other embodiments, it is arranged that the integrity check is conducted in parallel with the delivery of the requested material to the processor, with appropriate action (e.g. both processors 12 and 14 are reset) being taken before the transfer is completed in the event that the integrity check fails.

In the main embodiment, integrity check failures in the boot procedure cause the telephone 10 to reset. In certain embodiments, it may be desirable to include redundant copies of important sets within the flash memory 20 so that random events, such as those caused by cosmic rays, can be coped with.

In the main embodiment, a flash memory 20 is used. In other embodiments, however, the flash memory 20 may be replaced by any other form of non-volatile storage. The flash controller 18 may be implemented to drive a single type of non-volatile storage but, in the case of flash devices, it is possible to implement the flash controller 18 to determine the flash access mechanisms using the flash contents via a standard such as the common flash interface (CFI).

The main embodiment includes two processors. In other embodiments, there may be a different number of processors.

The main embodiment uses a single flash memory 20. In other embodiments, there may be a plurality of memories that the processor or processors can access only through the controller 18.

In the main embodiment, the processors 12 and 14 have separate blocks 22 and 24 within the RAM 16. In other embodiments, there may be a single RAM common to the processors.

In the main embodiment, the flash controller 18 delivers requested material to a processor by loading that material into the RAM block of that processor by direct memory access (DMA). In other embodiments, other mechanisms may be used for preventing processors other than the requesting processor from using material retrieved from the flash memory 20. For example, requested material could be fetched from the flash memory 20 not to the RAM 16 but to a register within the requesting processor.

In the main embodiment, the invention is implemented within a telephone 10. The invention can of course be implemented in other devices, such as PDAs and laptop and desktop computers.

In the main embodiment, the flash controller 18 contains ROM areas 26 and 28 storing boot code for processors 12 and 14. In other embodiments, these sections of boot code may be stored in the flash memory 20 and be delivered from there to the processors 12 and 14 by the flash controller 18, subject to the boot code passing an integrity check performed by the HMAC mechanism 30.

In the main embodiment, the integrity checking mechanism operates according to the HMAC standard and the encryption mechanism operates according to the AES standard. It will be apparent that, in other embodiments, different integrity checking and encryption mechanisms may be used.

In the main embodiment, the flash controller 18 is implemented entirely in silicon. In other embodiments however, the flash controller 18 may be implemented as a processor with only basic functionality, its higher functionality being provided by program code stored in an associated non-volatile memory. This permits alterations to be made to the functionality of the flash controller 18 (for example, if bugs or security loop holes are found in the operation of the flash controller).

In the main embodiment, elements 12 to 18 are implemented as a SoC. This need not be the case, although there will be some loss of security. If the elements 12 to 18 are implemented using multiple independent chips, then these could be arranged to occupy a multi-chip package to enhance security.

In the main embodiment, the processor 12 runs program code from a ROM within the SoC whilst in the initialisation mode. In one variant, the processor 12 runs program code from a different source whilst in the initialisation mode, in which case it is preferable that that code is first validated by the processor 12 running under the control of program code from a ROM in the SoC.

Although various modifications to the main embodiment have been described, it will be apparent to any reader skilled in this art that many other variations are possible. The scope of the invention is not limited by the range of variants actually described but by the attached claims interpreted in the light of the description.

1. A data processing system comprising: data processing means, control means and an integrated circuit chip containing non-volatile storage means, wherein the control means is provided between said chip and the processing means and provides all access to said chip by the processing means and the control means is arranged to check, upon the processing means requiring certain material in the non-volatile storage means, the validity of the required material and prevent the use of the required material by the processing means if invalid.

2. A data processing system according to claim 1, wherein said required material is held in encrypted form in said chip and the control means is arranged to decrypt said required material as a precursor to checking its validity.

3. A data processing system according to claim 1, wherein the processing means comprises more than one data processor.

4. A data processing system according to claim 1, wherein boot code for the processing means is provided outside said chip.

5. A data processing system according to claim 1, further comprising random access storage means into which the controller is capable of delivering material from said chip for access by the processing means.

6. A data processing system as claimed in claim 5, wherein the control means is arranged to deliver said required material to the random access storage means only if the validity check indicates that the required material is valid.

7. A data processing system according to claim 5, wherein the control means is arranged to allow the processing means to access the required material as fully or partially retrieved to the random access storage means only if the validity check indicates that it is valid.

8. A data processing system according to claim 1, wherein said chip is a flash memory chip.

9. A data processing system according to claim 1, wherein the required material is data, instructions or a combination of both.

10. A data processing system according to claim 9, wherein the required material is required for booting the processing means or a part thereof.

11. A data processing system according to claim 1, wherein the control means calculates, upon the processing means requesting to write material to said chip, from the material to be written an integrity metric that can be used to authenticate that material when fetched from said chip.

12. A data processing system according to claim 1, wherein the processing means and the control means are integrated within a system on a chip that co-operates with said chip containing non-volatile storage.

13. A data processing system according to claim 1, wherein the processing means, the control means and the random access storage means are integrated together as a system on a chip that co-operates with said chip containing non-volatile storage.

14. (canceled)

15. (canceled)
